(19) United States
(12) Patent Application Publication
(10) Pub. No.: US 2023/0153659 A1
(43) Pub. Date: May 18, 2023

(54) DECISION SIMULATOR USING A KNOWLEDGE GRAPH

(71) Applicant: SAP SE, Walldorf (DE)

(72) Inventors: Priti Mulchandani, Dublin (IE); Michael Burwig, Berlin (DE); Samuel Boehme, Berlin (DE); Adelya Alisherovna Fatykhova, Berlin (DE); Yating Li, Berlin (DE); Tyler James Marangi, Berlin (DE)

(21) Appl. No.: 17/986,777

(22) Filed: Nov. 14, 2022

Related U.S. Application Data
(63) Continuation of application No. 63/279,475, filed on Nov. 15, 2021.

(51) Int. Cl. G06N 5/04

(52) U.S. Cl. CPC G06N 5/045; G06Q 10/0637

(57) ABSTRACT

Example methods and systems are directed to simulating conditions for decision making. To help with decision making, simulated conditions may be used to generate probabilities of different events. Historical time-series data may be used to generate a probability distribution of values for simulated conditions. A user may be enabled to modify the probability distribution that was generated from the historical time-series data. The relationship between the value being simulated and other values may be represented by a knowledge graph. The knowledge graph may include nodes that represent arithmetic operations, input variables, external functions, database queries, and predictions. By running thousands of simulations with different values for input variables, as determined by the probability distributions for the input variables, a range of possible outcomes and their probabilities is generated. The simulation results are presented to a user to facilitate decision making.

### RELATED APPLICATIONS

This non-provisional patent application claims priority to U.S. Provisional Patent Application No. 63/297,475, filed Nov. 15, 2021 and entitled “Augmented xP&A,” which is hereby incorporated by reference in its entirety.

### TECHNICAL FIELD

The subject matter disclosed herein generally relates to scenario planning. Specifically, the present disclosure addresses systems and methods to apply reasoning and probabilistic techniques on data to generate and explain scenarios.

### BACKGROUND

Planning for different aspects of decision-making is performed in isolation. Volatile conditions cause significant effort to be spent in reconciling the independent decisions and adjusting decisions to actual conditions. Many decisions are made based on gut feeling rather than on data analysis.

### BRIEF DESCRIPTION OF THE DRAWINGS

Some embodiments are illustrated by way of example and not limitation in the figures of the accompanying drawings.

FIG. 1 is a network diagram illustrating a network environment suitable for simulating conditions for decision making, according to some example embodiments.

FIG. 2 is a block diagram of a simulation server, according to some example embodiments, suitable for simulating conditions for decision making.

FIGS. 3-4 are block diagrams of a database schema, according to some example embodiments, suitable for use in simulating conditions for decision making.

FIG. 5 is a block diagram of a knowledge graph, according to some example embodiments, suitable for use in simulating conditions for decision making.

FIG. 6 is a block diagram of an example user interface suitable for use in generating probability distributions for use in simulating conditions for decision making.

FIG. 7 is a block diagram of an example user interface suitable for displaying and editing a knowledge graph suitable for use in simulating conditions for decision making.

FIG. 8 is a block diagram of an example user interface suitable for displaying results of simulating conditions for decision making.

FIG. 9 is a block diagram of an example user interface suitable for modifying parameters for simulating conditions for decision making.

FIG. 10 is a flowchart illustrating operations of a method suitable for simulating conditions for decision making, according to some example embodiments.

FIG. 11 is a block diagram showing one example of a software architecture for a computing device.

FIG. 12 is a block diagram of a machine in the example form of a computer system within which instructions may be executed for causing the machine to perform any one or more of the methodologies discussed herein.

### DETAILED DESCRIPTION

Example methods and systems are directed to simulating conditions for decision making. Whether a decision results in a desired outcome may depend on conditions outside of the decision-makers control. For example, producing widgets is profitable only if the value of the widgets exceeds the cost of their production, but the entity investing in a widget factory cannot control the value of the widgets and the cost of the inputs in the future. To help with decision making, simulated conditions may be used to generate probabilities of different events (e.g., profitability).

Historical time-series data may be used to generate a probability distribution of values for simulated conditions. A probability distribution gives the probabilities of occurrences of different possible outcomes. For example, a bell curve centered on a mean historical value for an input variable may be used. The bell curve may have a standard deviation determined from the historical values. A user may be enabled to modify the probability distribution that was generated from the historical time-series data.

The relationship between the value being simulated (e.g., profit margin) and other values (e.g., input variables) may be represented by a knowledge graph. The knowledge graph may include nodes that represent arithmetic operations, input variables, external functions, database queries, and predictions. The edges of the knowledge graph may represent relationships between nodes. Key performance indicators (KPIs) may be represented as nodes. The KPI may be calculated by evaluation of the subgraph that is derived by traversal of the knowledge graph, starting at the KPI node. Semantic nodes may allow for reasoning to uncover conclusions and derive recommended actions.

By running thousands of simulations with different values for input variables, as determined by the probability distributions for the input variables, a range of possible outcomes and their probabilities is generated. The simulation results are presented to a user to facilitate decision making.

When these effects are considered in aggregate, one or more of the methodologies described herein may obviate a need for certain efforts or resources that otherwise would be involved in simulating conditions for decision making. Computing resources used by one or more machines, databases, or networks may similarly be reduced. Examples of such computing resources include processor cycles, network traffic, memory usage, data storage capacity, power consumption, and cooling capacity.

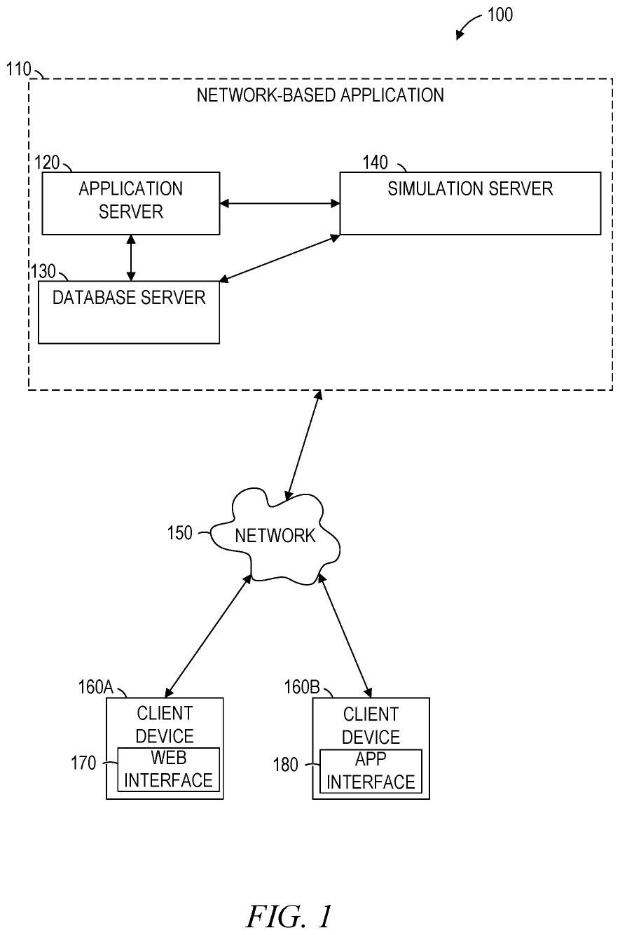

FIG. 1 is a network diagram illustrating a network environment 100 suitable for simulating conditions for decision making, according to some example embodiments. The network environment 100 includes a network-based application 110, client devices 160A and 160B, and a network 150. The network-based application 110 is provided by application server 120 in communication with a database server 130 and a simulation server 140. The application server 120 accesses application data (e.g., application data stored by the database server 130) to provide one or more applications to the client devices 160A and 160B via a web interface 170 or an application interface 180. For example, the application server 120 may provide a configuration application that receives commands from the client devices 160, configures priorities based on the commands, and sends status messages to the requesting client device 160.

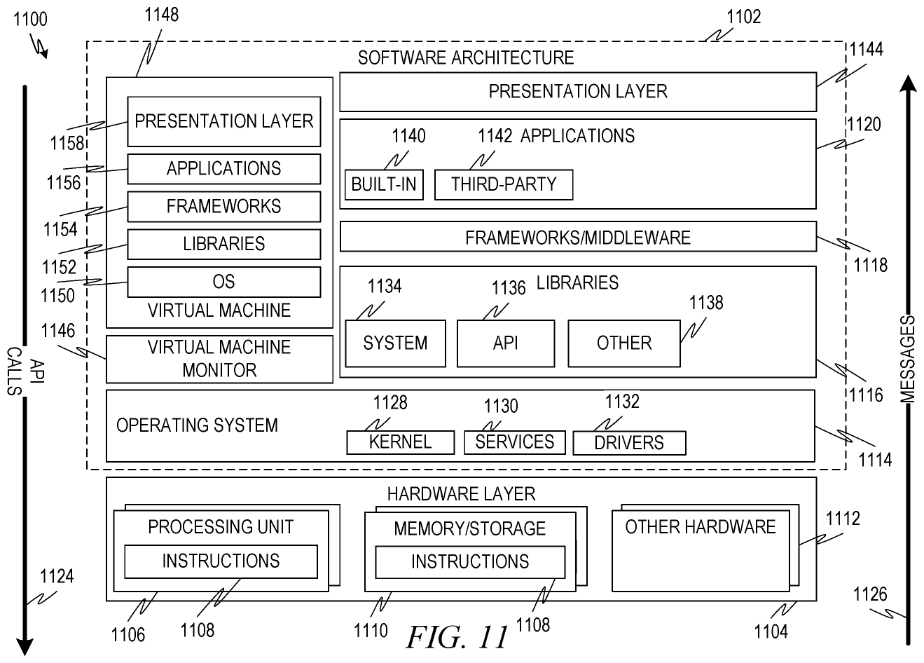

The application server 120, the database server 130, the simulation server 140, and the client devices 160A and 160B may each be implemented in a computer system, in whole or in part, as described below with respect to FIG. 11. The client devices 160A and 160B may be referred to collectively as client devices 160 or generically as a client device 160.

The simulation server 140 simulates possible outcomes for different options available to the user of the client device 160. The web interface 170 or the application interface 180 may provide a user interface that allows the user to configure the simulations. The results of the simulations may be provided by the simulation server 140 to the client device 160, enabling a user of the client device 160 to select an option based on the simulated results.

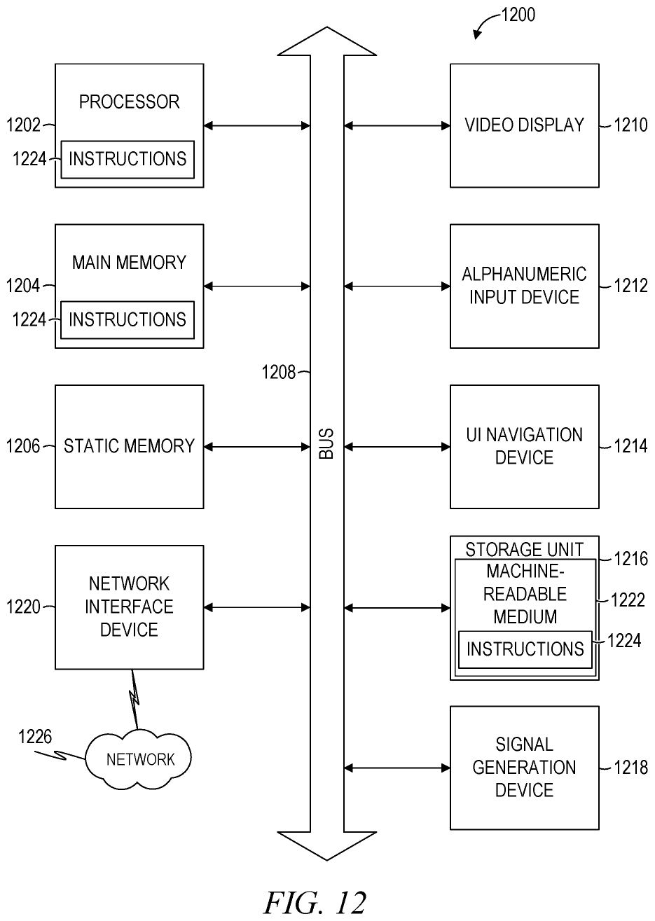

Any of the machines, databases, or devices shown in FIG. 1 may be implemented in a general-purpose computer, modified (e.g., configured or programmed) by software, to be a special-purpose computer to perform the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the simulation server 140, and the client devices 160A-160B are connected by the network 150. The network 150 may be any network that enables communication between or among machines, databases, and devices. Accordingly, the network 150 may be a wired network, a wireless network (e.g., a mobile or cellular network), or any suitable combination thereof. The network 150 may include one or more portions that constitute a private network, a public network (e.g., the Internet), or any suitable combination thereof.

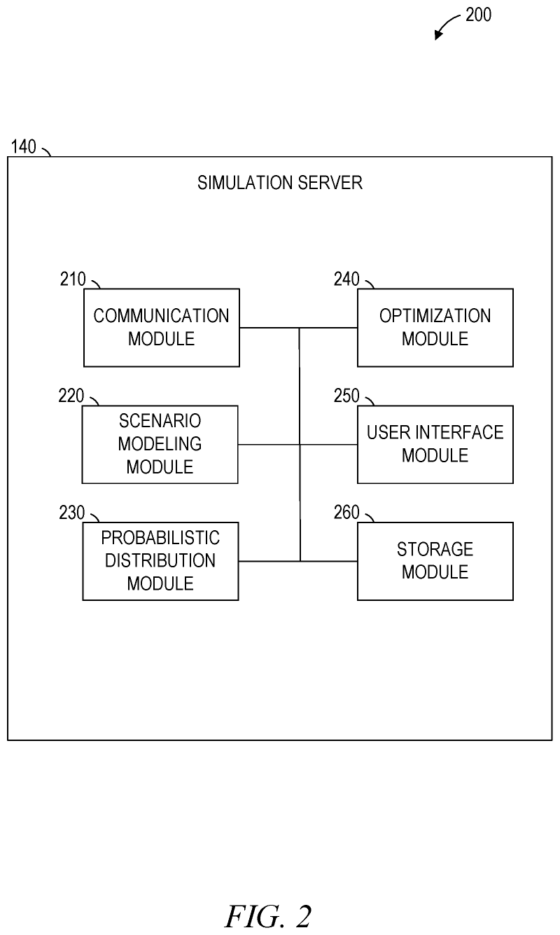

FIG. 2 is a block diagram 200 of a simulation server, according to some example embodiments, suitable for simulating conditions for decision making. The simulation server 140 is shown as including a communication module 210, a scenario modeling module 220, a probabilistic distribution module 230, an optimization module 240, a user interface module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the simulation server 140 and transmits data from the simulation server 140. For example, the communication module 210 may receive from the application server 120 of FIG. 1 or the database server 130 of FIG. 1, historical time series data to be used for scenario modeling. Communications sent and received by the communication module 210 may be intermediated by the network 150 of FIG. 1.

The probabilistic distribution module 230 may generate, for each of one or more input variables, a probability distribution for the variable. For example, an output profit variable may depend on input variables for income and expenses. Based on historical time series data, a probability distribution (e.g., a bell curve with a defined mean and standard deviation, a linear growth, an exponential growth, a uniform distribution, or any suitable combination thereof) may be determined for the input variable. The generating of the probability distribution for the values of each node of a knowledge graph may be performed using an element-wise sum of first differences of time series data corresponding to the node.

Based on the probability distributions for the input variables, the scenario modeling module 220 generates a probability distribution for the output variable. For example, a scenario may be modeled for each of a thousand randomly selected values from the input variable distributions and the thousand generated output variable values may comprise the output probability distribution.

The optimization module 240 may provide recommendations for aspects of a process that are under user control. For example, if the user can control the production of different types of widgets and the scenarios model demand for the different types of widgets, the optimization module 240 may recommend levels of production for each of the types of widgets.

The user may be able to control parameters of the probability distributions for the input variables using an interface provided by the user interface module 250. For example, the user interface module 250 may comprise a web server application that sends HTML, files via the network 150 that cause the web interface 170 of the client device 160A to render a user interface on a display device. The user interface may allow the user to select parameters of a probability distribution such as a range, a mean, a standard deviation, a distribution shape, or any suitable combination thereof. The user interface may also present recommendations from the optimization module, results generated by the scenario modeling module, or any suitable combination thereof.

The storage module 260 may store configuration data, simulation result data, input variable distribution data, or any combination thereof locally on the simulation server 140 (e.g., in a hard drive) or store data remotely. Examples of remote storage include network storage devices and the database server 130.

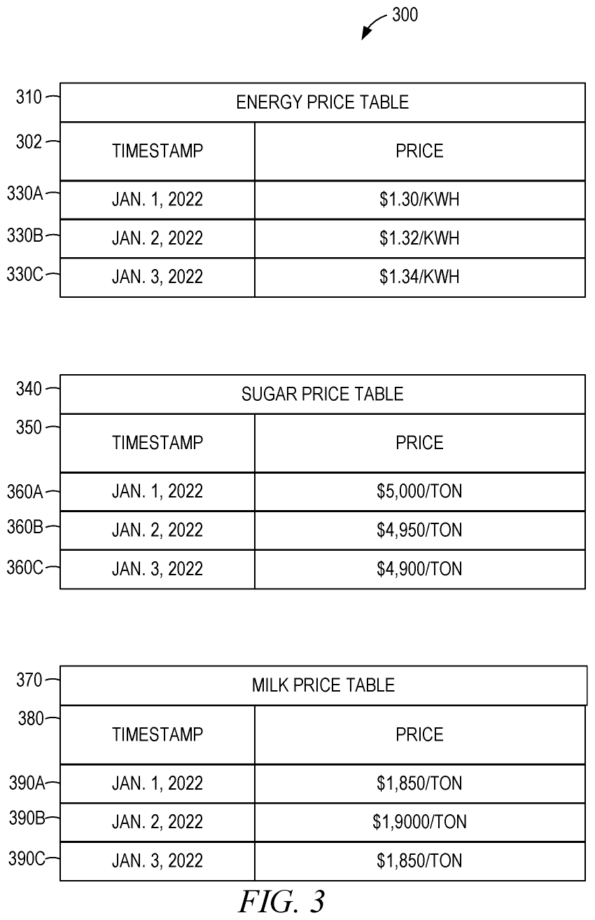

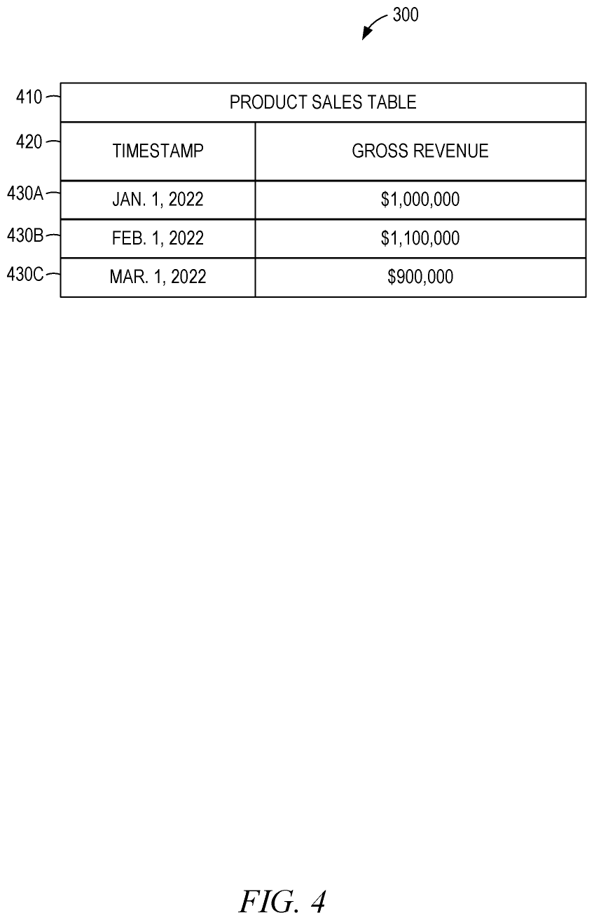

FIGS. 3-4 are a block diagram of a database schema 300, according to some example embodiments, suitable for use in simulating conditions for decision making. The database schema 300, in FIG. 3, includes an energy price table 310, a sugar price table 340, and a milk price table 370. FIG. 4 shows a product sales table 410 of the database schema 300. The energy price table 310 includes rows 330A, 330B, and 330C of a format 320. The sugar price table 340 includes rows 360A, 360B, and 360C of a format 350. The milk price table 370 includes rows 390A, 390B, and 390C of a format 380. Rows 430A, 430B, and 430C of the product stales table 410 are in a format 420. Though each of the tables 310, 340, 370, and 410 is shown with only three rows, tables with hundreds or thousands of rows are contemplated.

The format 320 of the energy price table 310 includes a timestamp field and a price field. Each of the rows 330A-330C stores data for the price of energy at the identified time. In the example of FIG. 3, each of the rows 330A-330C stores a spot energy price for one day. In some example embodiments, the granularity of the data is larger or smaller. For example, time series data may be stored with one entry per minute, per hour, per day, per week, per month, or per year. The sugar price table 340 stores time series data for the price of sugar. The milk price table 370 stores time series data for the price of milk.

Data from the energy price table 310 may be accessed by the probabilistic distribution module 230 to generate a probabilistic distribution for the price of energy. Likewise, data from the sugar price table 340 may be accessed by the probabilistic distribution module 230 to generate a probabilistic distribution for the price of sugar and data from the milk price table 370 may be used to generate a probabilistic distribution for the price of milk.

The product sales table 410 includes historical data for product sales. As shown by the format 420, each row 430A-430C includes a timestamp and gross revenue value. In the example of FIG. 4, the time series data is stored with monthly values. Accordingly, analysis of the data in the product sales table 410 may be used to generate a probability distribution for the gross revenue from product sales for future months.

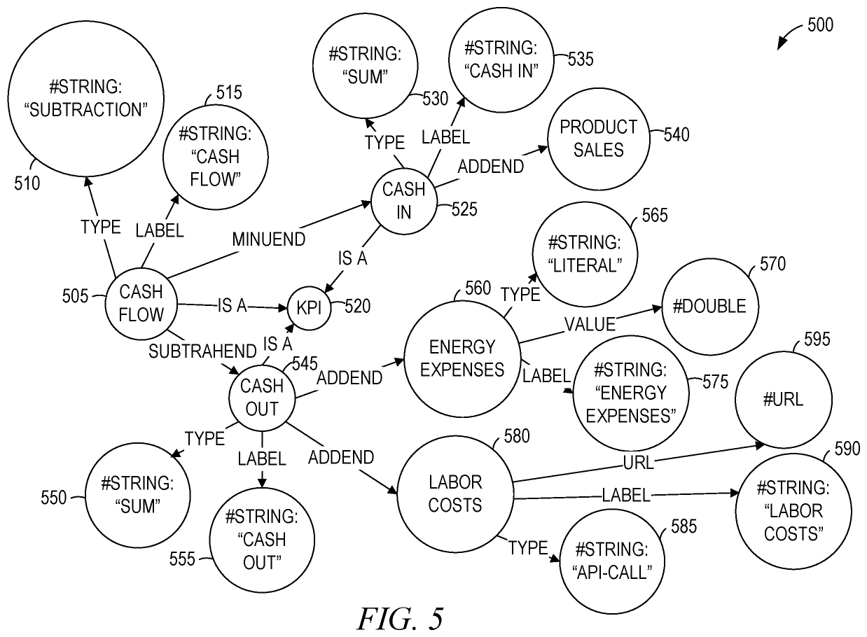

FIG. 5 is a block diagram of a knowledge graph 500, according to some example embodiments, suitable for use in simulating conditions for decision making. The knowledge graph 500 is a labeled directed acyclic graph data structure comprising nodes and edges. The graph is interpreted by a simulation engine at runtime to generate scenarios. The knowledge graph 500 may be built or modified by users through a modeling tool, automatically generated based on data, or any suitable combination thereof. The simulation engine may use different plugins to handle corresponding node types. For example, a type of a node may indicate that arithmetic operations should be performed, that external functions should be invoked using API calls, that data should be retrieved from a database, that the node represents an input variable, that the node represents an output variable, or any suitable combination thereof.

KPIs are associated with unique identifiers (e.g., Unique Resource Identifiers (URIs)) and a simulation node. Each KPI may be calculated by evaluation of the subgraph that is derived by traversal of the graph starting at the KPI node.

The knowledge graph 500 includes nodes 505, 510, 515, 520, 525, 530, 535, 540, 550, 555, 560, 565, 570, 575, 580, 585, 590, and 595. The knowledge graph 500 is a directed graph with the node 505 as the root node. The root node is the only node that does not have any parent nodes.

The node 505 is labeled “Cash Flow,” as indicated by the “label” relationship between the node 505 and the node 515. The node 505 is a subtraction node, as indicated by the “type” relationship between the node 505 and the node 510. The operands for the subtraction are the values of the nodes 545 (“Cash Out”) and 525 (“Cash In”). Each of the nodes 505, 525, and 545 are KPIs, as indicated by the “Is A” relationship between these three nodes and the node 520, labeled “KPI.”

To determine the cash flow, the values of the nodes 525 and 545 are first determined. The value of “Cash In” node 525 is determined by adding the values of one or more child nodes. In the example of FIG. 5, just one “Addend” node (the node 540) is shown, but additional nodes may be summed. The value of “Cash Out” node 545 is determined by summing the values of the nodes 560 and 580. The node 560, labeled “Energy Expenses,” has a double-precision value. The node 580, labeled “Labor Costs,” has a value to be determined through an API call, as indicated by the node 585, to a fixed URL, as indicated by the node 595.

When performing simulations, the values of one or more input variables may be determined based on input probability distributions. For example, the value used for the “Energy Expenses” node 560 may be randomly selected from a normal distribution with a mean and standard deviation determined based on historical time series data for energy expenses. For each simulation, traversal of the knowledge graph 500 will result in determination of a value for the KPIs of “Cash Flow,” “Cash In,” and “Cash Out.” When many such simulations are run, a probability distribution of the KPIs may be generated, which may aid in decision making. For example, if 90% of simulations show that costs exceed income in the future, substantial changes to the business may be in order.

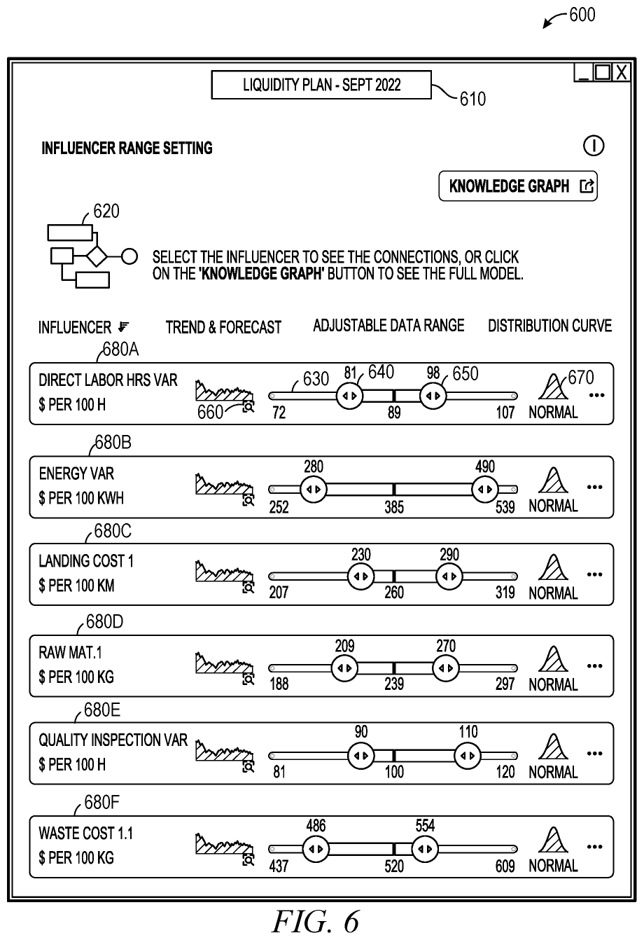

FIG. 6 is a block diagram of an example user interface 600 suitable for use in generating probability distributions for use in simulating conditions for decision making. The user interface 600 includes a title 610, information areas 680A, 680B, 680C, 680D, 680E, and 680F, and interactive components 620, 630, 640, 650, 660, and 670.

The title 610 indicates that the user interface 600 is for simulation of a liquidity plan for September 2022. Each of the information areas 680A-680F shows probability distribution data for a different input variable. In the example of FIG. 6, each input variable is a cost for labor, energy, landing, raw materials, quality inspection, or waste. In other examples, input variables may be revenue amounts or quantities other than money. For example, a simulation may be run to determine a likelihood of completing a project by a particular date and the input variables may be amounts of time that will be taken to perform portions of the project.

The interactive component 620 is operable to cause display of the knowledge graph being used for the simulation. For example, the knowledge graph 500 of FIG. 5 may be displayed in a user interface. The user interface may be operable to allow modification of the knowledge graph (e.g., by adding nodes, removing nodes, creating links between nodes, setting values of nodes, linking values of nodes to database records, linking values of nodes to API calls, or any suitable combination thereof). The input variables displayed in the information areas 680A-680F may be determined based on the knowledge graph. Thus, if the knowledge graph is edited using a user interface presented by use of the interactive component 620, the user interface 600 may be updated to reflect the changes.

The interactive component 630 shows a range of an input variable according to historical time-series data for the input variable. For example, values may have been in the range of $72 to $107 per 100 hours over a preceding time period (e.g., one month, one year, or ten years), with a mean value of $89. The interactive components 640 and 650 may be operable to select a subset of the range to be used for simulation. The minimum and maximum values of the selected range may be shown on or near the interactive components 640 and 650. Thus, in the example of FIG. 6, the selected range for labor costs is $81 to $98 per 100 hours. The probabilistic distribution module 230 of FIG. 2 may generate the probability distribution for the values of a node of the knowledge graph based on user input received by interactive components 640, 650, and 670, indicating a range of values and a distribution curve shape.

Additional information about the historical time-series data may be displayed in response to operation of the interactive component 660. For example, a user interface including a graph or table may be shown. The probability distribution may be determined by element-wise sum of the first differences of the time series with the value for the current time period.

The type of distribution may be selected using the interactive component 670. For example, clicking on or touching the interactive component 670 may cause a distribution selector to be presented. Using the distribution selector, the user may select from a plurality of distributions such as a normal distribution, a linear distribution, an exponential distribution, a binomial distribution, a Poisson distribution, or a chi-square distribution. During simulation, values for each input variable may be selected randomly within the range defined by the interactive components 640 and 650 and using the distribution selected by the interactive component 670.

Though only the interactive components 620-670 are labeled in FIG. 6, each of the information areas 680A-680F includes a separate copy of the interactive components 620-670. Each set of the interactive components 620-670 is operable to perform operations for the input variable of the corresponding information area. Thus, by use of the user interface 600, a user is enabled to configure the selection of input variables for scenario simulation.

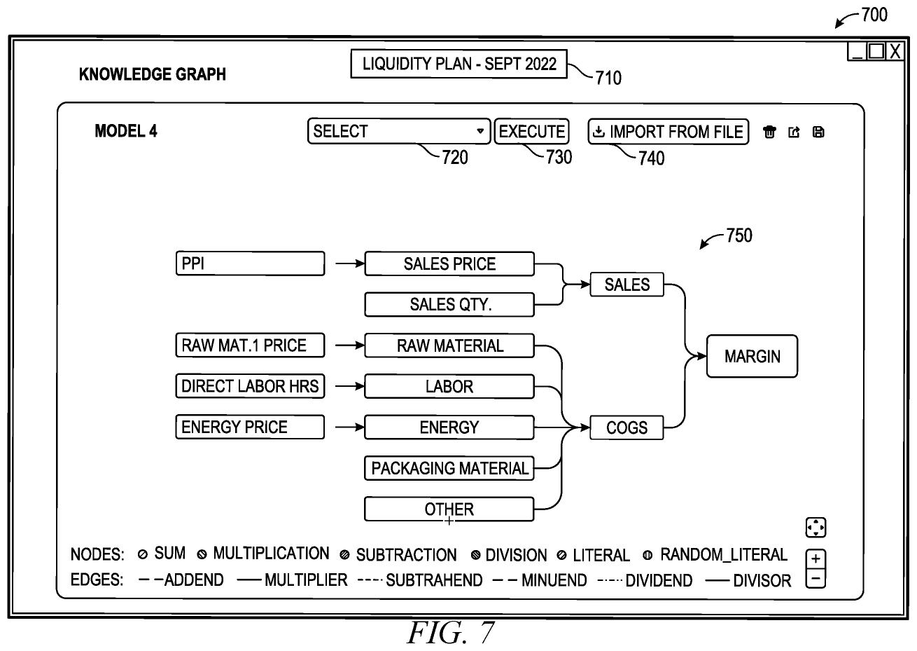

FIG. 7 is a block diagram of an example user interface 700 suitable for displaying and editing a knowledge graph suitable for use in simulating conditions for decision making. The user interface 700 includes a title 710, a selection field 720, a button 730, a button 740, and a knowledge graph 750.

The title 710 indicates that the user interface 700 is for selecting a knowledge graph for modeling a September 2022 liquidity plan. The selection field 720 is operable to select from a plurality of knowledge graphs. Alternatively, the button 740 may be used to cause a file picker to be presented, allowing the user to select a file to import a knowledge graph from. The knowledge graph 750 shows the current knowledge graph, and may be updated in response to selection of a different knowledge graph using the selection field 720 or the import button 740. The button 730 is operable to cause simulation to proceed with the knowledge graph 750.

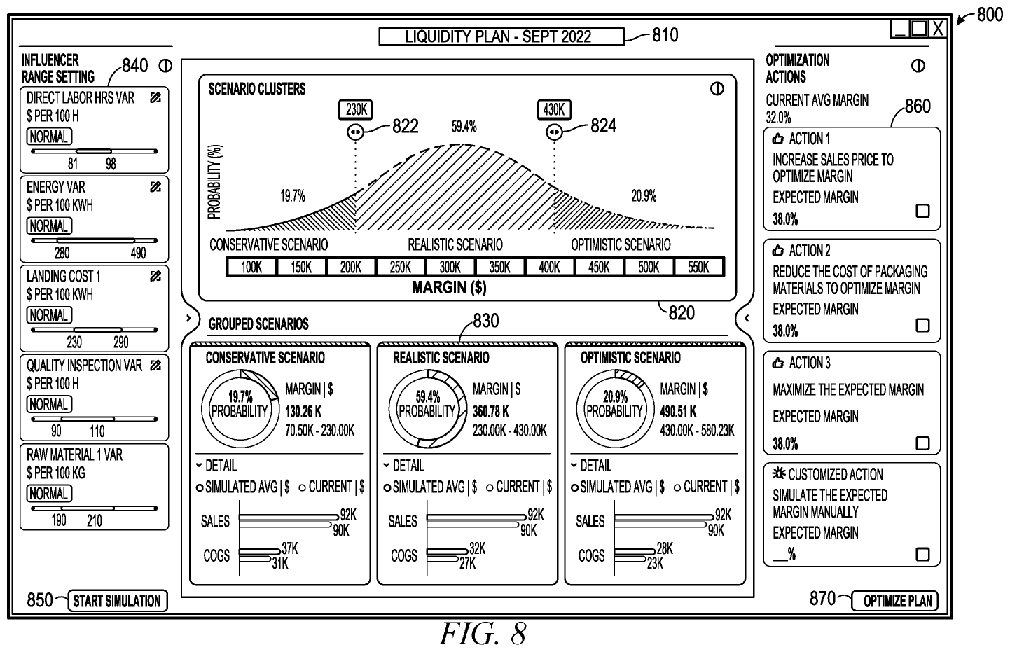

FIG. 8 is a block diagram of an example user interface 800 suitable for displaying results of simulating conditions for decision making. The user interface 800 may be displayed in response to operation of the button 730 of FIG. 7. The user interface 800 includes a title 810, scenario clusters area 820, grouped scenarios area 830, influencer range setting area 840, a button 850, optimization actions area 860, and a button 870.

The title 810 shows that the user interface 800 is presenting data regarding the September 2022 liquidity plan. The scenario clusters area 820 shows probabilities and amounts of outcomes of the simulations. The outcomes are grouped into conservative, realistic, and optimistic scenarios. The outcomes may be determined using Monte Carlo simulation. The probability of the outcome for each group is shown as 19.7%, 59.4%, and 20.9%, respectively. The user interface elements 822 and 824 may be operable to modify the boundaries of the three groups. For example, the user may click and drag on the user interface element 824 to adjust the upper bound of the realistic scenario group.

A Monte Carlo simulation models the probability of different outcomes by assigning multiple values to an uncertain variable, generating a result for each of the assigned values, and then averaging the result to obtain an estimate for the outcome. The name Monte Carlo is a reference to the gambling destination of Monte Carlo, Macau because many gambling games rely on uncertain variables. The selection of the values assigned to the uncertain variable may be based on a probability distribution (e.g., a linear distribution within a range, a bell curve distribution with a defined mean and standard deviation, or another distribution). The frequency of the outcomes may be used to generate an outcome probability distribution. For example, the expected value for the sum of two 6-sided dice may be determined by using a linear distribution in the range 1-6 for each die, then determining the sum of the two dice for each simulation. After many simulations, the result will be a bell curve centered at 7 and covering the range 2-12. By contrast, a static simulation could use the average value of 3.5 for each die and determine that the average value of the sum would be 7, but would not give any information about the relative likelihood of that value to other values, what range of output values covers the 50% most-likely results, the 90% most-likely results, or any other predetermined range.

The grouped scenarios area 830 shows additional information about the groups of scenarios. The grouped scenarios area 830 may be updated in response to use of the user interface elements 822 or 824 that changes which simulations are assigned to each group. For each group of scenarios, the grouped scenarios area 830 shows a probability of the result being in the group, a range for the output variable (margin, in the example of FIG. 8) for the group, and values for KPIs (sales and cost of goods sold (COGS), in the example of FIG. 8) for the group. Current values for the KPIs may be shown, for comparison.

The influencer range setting area 840 contains controls that are operable to adjust the probability distributions for input variables. When the user clicking and dragging on the ends of the ranges is detected, the ranges are updated. For example, the direct labor hours variable shows, in FIG. 8, a range of $81-$98 per 100 hours. The user may increase the upper end of the range by clicking on the right edge of the range and dragging to the right. Similarly, clicking on the button labeled “Normal” may be operable to cause a selector to be presented that may be used to select from multiple distribution shapes. After adjusting one or more input variable probability distributions, operation of the button 850 may cause the simulation to be re-run. In response to re-running the scenario, the scenario clusters area 820 and grouped scenarios area 830 are updated.

The optimization actions area 860 shows one or more recommended actions based on the results of the simulations. For example, the recommended action may be for a particular sales price, to reduce a particular cost, to make multiple modifications to reach a particular profit margin, or any suitable combination thereof. The user may select one or more of the recommendations and then push the button 870 to apply the selected changes. The recommended action may be generated internally as a target value for a node of the knowledge graph. Natural language processing may be applied to the knowledge graph and the target value for the node to generate an explanation for the recommended action. In response to detecting, via an element of the optimization actions area 860, a user interaction, the user interface module 250 of FIG. 2 may cause display of another user interface (e.g., a pop-up window) comprising the explanation of the recommended action.

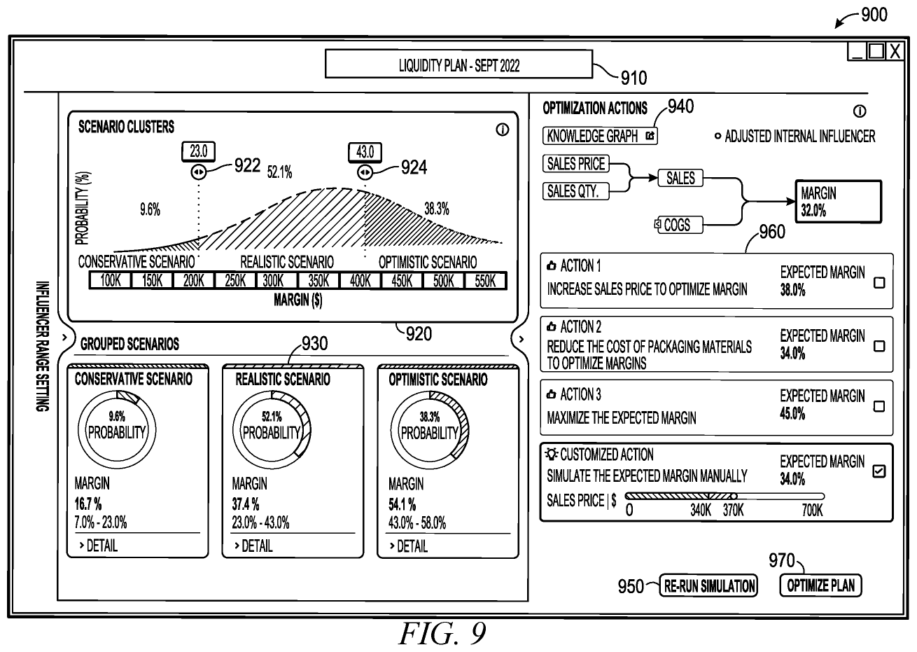

FIG. 9 is a block diagram of an example user interface 900 suitable for modifying parameters for simulating conditions for decision making. The user interface 900 includes a title 910, a scenario clusters area 920, a grouped scenarios area 930, a knowledge graph area 940, a button 950, an optimization actions area 960, and a button 970.

The title 910 shows that the user interface 900 is presenting data regarding the September 2022 liquidity plan. The scenario clusters area 920 shows probabilities and amounts of outcomes of the simulations. The outcomes are grouped into conservative, realistic, and optimistic scenarios. The probability of the outcome for each group is shown as 9.6%, 52.1%, and 38.3%, respectively. The user interface elements 922 and 924 may be operable to modify the boundaries of the three groups. For example, the user may click and drag on the user interface element 924 to adjust the upper bound of the realistic scenario group.

The grouped scenarios area 930 shows additional information about the groups of scenarios. The grouped scenarios area 930 may be updated in response to use of the user interface elements 922 or 924 that changes which simulations are assigned to each group. For each group of scenarios, the grouped scenarios area 930 shows a probability of the result being in the group, a range for the output variable (margin, in the example of FIG. 9) for the group.

The knowledge graph area 940 shows a portion of the knowledge graph being used for the simulations. The knowledge graph area 940 may include controls that are operable to manipulate the knowledge graph or to cause a user interface suitable for manipulating the knowledge graph to be presented. After modifying the knowledge graph, the button 950 may be used to re-run the simulation with the updated knowledge graph.

The optimization actions area 960 shows one or more recommended actions based on the results of the simulations. For example, the recommended action may be for a particular sales price, to reduce a particular cost, to make multiple modifications to reach a particular profit margin, or any suitable combination thereof. A customized action may allow the user to set a value or range of an input variable. For example, the user may set the range for the sales price. The user may select one or more of the recommendations and then push the button 970 to apply the selected changes.

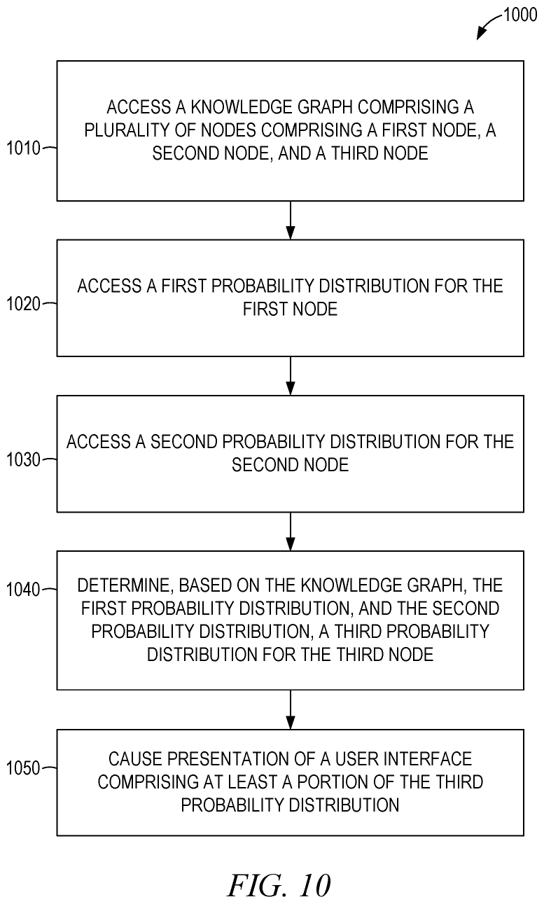

FIG. 10 is a flowchart illustrating operations of a method 1000 suitable for simulating conditions for decision making, according to some example embodiments. The method 1000 includes operations 1010, 1020, 1030, 1040, and 1050. By way of example and not limitation, the method 1000 may be performed by the simulation server 140 of FIG. 1, using the modules, databases, structures, and user interfaces shown in FIGS. 2-9.

In operation 1010, the scenario modeling module 220 of FIG. 2 accesses a knowledge graph comprising a plurality of nodes comprising a first node, a second node, and a third node. For example, the knowledge graph may be composed of nodes and edges, the nodes comprising a root node for an attribute to be modeled, with each edge linking two nodes and indicating a relationship between the two nodes. For example, the knowledge graph 500 of FIG. 5 may be accessed, comprising the first node 525 for “cash in,” the second node 545 for “cash out,” and the third (root) node 505 for the attribute being modeled, “cash flow.”

The scenario modeling module 220, in operation 1020, accesses a first probability distribution for the first node. In operation 1030, the scenario modeling module 220 accesses a second probability distribution for the second node. For example, historical data from the product sales table 410 may be accessed and used to determine a probability distribution for the node 525. Similarly, historical data from the energy price table 310 may be accessed and used to determine a probability distribution for the node 545. The probability distribution may be modified by user inputs received via the user interfaces 600, 800, or 900. The example method 1000 is described as accessing a probability distribution for two nodes, but any number of input nodes may be used for the simulation. For example, the knowledge graph 500 shows nodes 540 and 580, for product sales and labor costs, respectively. Each of these nodes may be associated with a different probability distribution and used as a component for simulating the cash flow.

In operation 1040, based on the knowledge graph, the first probability distribution, and the second probability distribution, the scenario modeling module 220 determines a third probability distribution for the third node. For example, a thousand simulations may be run. For each simulation, a random value in the first and second probability distributions is selected according to the probability distributions. Thus, for a normal distribution, the probability of selecting a value in the middle of the range is much higher than the probability of selecting a maximum or minimum value. The value of the third node is determined for each simulation. Some values will occur in multiple simulations. By counting the number of occurrences of each value for the attribute and dividing by the number of simulations, a percentage probability for each value may be determined, resulting in a probability distribution. The knowledge graph informs the relationship between the attribute being modeled and the input variables.

The user interface module 250 of FIG. 2, in operation 1050, causes presentation of a user interface comprising at least a portion of third probability distribution. For example, the user interface 800 of FIG. 8 may be presented, including a probability that the simulated attribute (margin) will be under $230,000; will be between $230,000 and $430,000; or will be greater than $430,000.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors, a knowledge graph comprising of a plurality of nodes, the plurality of nodes comprising a first node, a second node, and a third node; accessing, by the one or more processors, a first probability distribution for the first node; accessing, by the one or more processors, a second probability distribution for the second node; determining, by the one or more processors and based on the knowledge graph, the first probability distribution, and the second probability distribution, a third probability distribution for the third node; and causing, by the one or more processors, presentation of a user interface comprising at least a portion of the third probability distribution.

In Example 2, the subject matter of Example 1 includes determining, based on historical data, the first probability distribution for the first node.

In Example 3, the subject matter of Examples 1-2, wherein the user interface further comprises a recommended action based on the third probability distribution.

In Example 4, the subject matter of Example 3 includes generating, using natural language processing, an explanation for the recommended action; and in response to detecting, via the user interface, a user interaction, causing display of a second user interface comprising the explanation of the recommended action.

In Example 5, the subject matter of Examples 1-4 includes generating the first probability distribution for the first node using an element-wise sum of first differences of time series data corresponding to the first node.

In Example 6, the subject matter of Examples 1-5 includes generating the first probability distribution for the first node based on user input indicating a range of values and a distribution curve shape.

In Example 7, the subject matter of Examples 1-6, wherein the determining of the third probability distribution for the third node comprises performing Monte Carlo simulation.

Example 8 is a system comprising: a memory that stores instructions; and one or more processors configured by the instructions to perform operations comprising: accessing a knowledge graph comprising a plurality of nodes, the plurality of nodes comprising a first node, a second node, and a third node; accessing a first probability distribution for the first node; accessing a second probability distribution for the second node; determining, based on the knowledge graph, the first probability distribution, and the second probability distribution, a third probability distribution for the third node; and causing presentation of a user interface comprising at least a portion of the third probability distribution.

In Example 9, the subject matter of Example 8, wherein the operations further comprise: determining, based on historical data, the first probability distribution for the first node.

In Example 10, the subject matter of Examples 8-9, wherein the user interface further comprises a recommended action based on the third probability distribution.

In Example 11, the subject matter of Example 10, wherein the operations further comprise: generating, using natural language processing, an explanation for the recommended action; and in response to detecting, via the user interface, a user interaction, causing display of a second user interface comprising the explanation of the recommended action.

In Example 12, the subject matter of Examples 8-11, wherein the operations further comprise: generating the first probability distribution for the first node using an element-wise sum of first differences of time series data corresponding to the first node.

In Example 13, the subject matter of Examples 8-12, wherein the operations further comprise: generating the first probability distribution for the first node based on user input indicating a range of values and a distribution curve shape.

In Example 14, the subject matter of Examples 8-13, wherein the determining of the third probability distribution for the third node comprises performing Monte Carlo simulation.

Example 15 is a non-transitory computer-readable medium that stores instructions that, when executed by one or more processors, cause the one or more processors to perform operations comprising: accessing a knowledge graph comprising a plurality of nodes, the plurality of nodes comprising a first node, a second node, and a third node; accessing a first probability distribution for the first node; accessing a second probability distribution for the second node; determining, based on the knowledge graph, the first probability distribution, and the second probability distribution, a third probability distribution for the third node; and causing presentation of a user interface comprising at least a portion of the third probability distribution.

In Example 16, the subject matter of Example 15, wherein the operations further comprise: determining, based on historical data, the first probability distribution for the first node.

In Example 17, the subject matter of Examples 15-16, wherein the user interface further comprises a recommended action based on the third probability distribution.

In Example 18, the subject matter of Example 17, wherein the operations further comprise: generating, using natural language processing, an explanation for the recommended action; and in response to detecting, via the user interface, a user interaction, causing display of a second user interface comprising the explanation of the recommended action.

In Example 19, the subject matter of Examples 15-18, wherein the operations further comprise: generating the first probability distribution for the first node using an element-wise sum of first differences of time series data corresponding to the first node.

In Example 20, the subject matter of Examples 15-19, wherein the operations further comprise: generating the first probability distribution for the first node based on user input indicating a range of values and a distribution curve shape.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

FIG. 11 is a block diagram 1100 showing one example of a software architecture 1102 for a computing device. The architecture 1102 may be used in conjunction with various hardware architectures, for example, as described herein. FIG. 11 is merely a non-limiting example of a software architecture, and many other architectures may be implemented to facilitate the functionality described herein. A representative hardware layer 1104 is illustrated and can represent, for example, any of the above referenced computing devices. In some examples, the hardware layer 1104 may be implemented according to the architecture of the computer system of FIG. 11.

The representative hardware layer 1104 comprises one or more processing units 1106 having associated executable instructions 1108. Executable instructions 1108 represent the executable instructions of the software architecture 1102, including implementation of the methods, modules, subsystems, and components, and so forth described herein and may also include memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of the software architecture 1102.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and presentation layer 1144. Operationally, the applications 1120 and/or other components within the layers may invoke application programming interface (API) calls 1124 through the software stack and access a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of an interrupt and, in response, cause the architecture 1102 to pause its current processing and execute an interrupt service routine (ISR) when an interrupt is accessed.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 may provide a higher-level common infrastructure that may be utilized by the applications 1120 and/or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. Third-party applications 1142 may include any of the built-in applications as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system libraries 1134, API libraries 1136, and other libraries 1138), and frameworks/middleware 1118 to create user interfaces to interact with users of the system. Alternatively, or additionally, in some systems, interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine 1148 such as an operating system 1150, libraries 1152, frameworks/middleware 1154, applications 1156 and/or presentation layer 1158. These layers of software architecture executing within the virtual machine 1148 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 12 is a block diagram of a machine in the example form of a computer system 1200 within which instructions 1224 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation (or cursor control) device 1214 (e.g., a mouse), a storage unit 1216, a signal generation device 1218 (e.g., a speaker), and a network interface device 1220.

### Machine-Readable Medium

The storage unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media 1222.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding, or carrying instructions 1224 for execution by the machine and that cause the machine to perform any one or more of the methodologies of the present disclosure, or that is capable of storing, encoding, or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, a knowledge graph comprising a plurality of nodes, the plurality of nodes comprising a first node, a second node, and a third node;
accessing, by the one or more processors, a first probability distribution for the first node;
accessing, by the one or more processors, a second probability distribution for the second node;
determining, by the one or more processors and based on the knowledge graph, the first probability distribution, and the second probability distribution, a third probability distribution for the third node; and
causing, by the one or more processors, presentation of a user interface comprising at least a portion of the third probability distribution.

2. The method of claim 1, further comprising:
determining, based on historical data, the first probability distribution for the first node.

3. The method of claim 1, wherein the user interface further comprises a recommended action based on the third probability distribution.

4. The method of claim 3, further comprising:
generating, using natural language processing, an explanation for the recommended action; and
in response to detecting, via the user interface, a user interaction, causing display of a second user interface comprising the explanation of the recommended action.

5. The method of claim 1, further comprising:
generating the first probability distribution for the first node using an element-wise sum of first differences of time series data corresponding to the first node.

6. The method of claim 1, further comprising:
generating the first probability distribution for the first node based on user input indicating a range of values and a distribution curve shape.

7. The method of claim 1, wherein the determining of the third probability distribution for the third node comprises performing Monte Carlo simulation.

8. A system comprising:
a memory that stores instructions; and
one or more processors configured by the instructions to perform operations comprising:
accessing a knowledge graph comprising a plurality of nodes, the plurality of nodes comprising a first node, a second node, and a third node;
accessing a first probability distribution for the first node;
accessing a second probability distribution for the second node;
determining, based on the knowledge graph, the first probability distribution, and the second probability distribution, a third probability distribution for the third node; and
causing presentation of a user interface comprising at least a portion of the third probability distribution.

9. The system of claim 8, wherein the operations further comprise:
determining, based on historical data, the first probability distribution for the first node.

10. The system of claim 8, wherein the user interface further comprises a recommended action based on the third probability distribution.

11. The system of claim 10, wherein the operations further comprise:
generating, using natural language processing, an explanation for the recommended action; and
in response to detecting, via the user interface, a user interaction, causing display of a second user interface comprising the explanation of the recommended action.

12. The system of claim 8, wherein the operations further comprise:
generating the first probability distribution for the first node using an element-wise sum of first differences of time series data corresponding to the first node.

13. The system of claim 8, wherein the operations further comprise:
generating the first probability distribution for the first node based on user input indicating a range of values and a distribution curve shape.

14. The system of claim 8, wherein the determining of the third probability distribution for the third node comprises performing Monte Carlo simulation.

15. A non-transitory computer-readable medium that stores instructions that, when executed by one or more processors, cause the one or more processors to perform operations comprising:
accessing a knowledge graph comprising a plurality of nodes, the plurality of nodes comprising a first node, a second node, and a third node;
accessing a first probability distribution for the first node;
accessing a second probability distribution for the second node;
determining, based on the knowledge graph, the first probability distribution, and the second probability distribution, a third probability distribution for the third node; and
causing presentation of a user interface comprising at least a portion of the third probability distribution.

16. The non-transitory computer-readable medium of claim 15, wherein the operations further comprise:
determining, based on historical data, the first probability distribution for the first node.

17. The non-transitory computer-readable medium of claim 15, wherein the user interface further comprises a recommended action based on the third probability distribution.

18. The non-transitory computer-readable medium of claim 17, wherein the operations further comprise:
generating, using natural language processing, an explanation for the recommended action; and
in response to detecting, via the user interface, a user interaction, causing display of a second user interface comprising the explanation of the recommended action.

19. The non-transitory computer-readable medium of claim 15, wherein the operations further comprise:
generating the first probability distribution for the first node using an element-wise sum of first differences of time series data corresponding to the first node.

20. The non-transitory computer-readable medium of claim 15, wherein the operations further comprise:
generating the first probability distribution for the first node based on user input indicating a range of values and a distribution curve shape.
